(19) United States
(12) Patent Application Publication
(10) Pub. No.: US 2018/0363804 A1
(43) Pub. Date: Dec. 20, 2018

(54) Boring Head for copper tubing

(71) Applicant: Kwon J. PARK, Diamond Bar, CA (US)

(72) Inventor: Kwon J. PARK, Diamond Bar, CA (US)

(21) Appl. No.: 15/624,676

(22) Filed: Jun. 15, 2017

(51) Int. Cl. F16L 1/028; G01B 5/12; E21B 7/20; E21B 10/36

(52) U.S. Cl. CPC F16L 1/028; G01B 5/12; F16L 9/02; E21B 10/36; E21B 7/205

(57) ABSTRACT

A boring head for copper tubing is provided. The boring head for copper tubing comprises a cylindrical body, a conic point, and a fixing hole. The cylindrical body has a predetermined inner diameter and a predetermined outer diameter with a front opening, a rear opening, and a concentric rear end portion. The conic point extends from the front opening of the cylindrical body, and the conic point is configured to penetrate and bore a hole through an external medium. The fixing hole is provided through a side wall of the cylindrical body and configured to fix a copper tube put into the cylindrical body. The conic point makes a hole through the external medium, leading the copper tube through the hole.

### BACKGROUND OF THE INVENTION

The present invention relates to a boring head for copper tubing.

In the community, there are many occasions, in which a copper pipe is deployed through an external medium such as soil or a block of cement or concrete. In such a case, it is possible to dig up the external medium down to a desirable depth, lay the pipe, and bury them up afterwards.

However, in the above practice, the work must be time-consuming, of high cost, and messy.

Therefore, the whole procedure may be nice to be improved with a suitable tool, cutting cost and work a lot.

Hopefully with such improvements, the job can be done even without disturbing the soil or concrete block.

Accordingly, a need for a boring head for copper tubing has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a boring head for copper tubing, especially in a crowded work space.

An aspect of the invention provides a boring head for copper tubing.

The boring head for copper tubing comprises a cylindrical body, a conic point, and a fixing hole.

The cylindrical body has a predetermined inner diameter and a predetermined outer diameter with a front opening, a rear opening, and a concentric rear end portion.

The conic point extends from the front opening of the cylindrical body, and the conic point is configured to penetrate and bore a hole through an external medium.

The fixing hole is provided through a side wall of the cylindrical body and configured to fix a copper tube put into the cylindrical body.

The conic point makes a hole through the external medium, leading the copper tube through the hole.

The conic point may have a predetermined cross-sectional angle, which is determined by the external medium.

The predetermined cross-sectional angle may be in a range from about 15 degrees to about 45 degrees.

Still, the predetermined cross-sectional angle may be from about 20 degrees to about 30 degrees.

Preferably, the predetermined cross-sectional angle may be about 25 degrees.

The thickness of the cylindrical body may be approximately one fourth to one sixth of the diameter of the inner diameter of the cylindrical body.

The cylindrical body and the conic point may be formed monolithically or integrally.

The cylindrical body and the conic point may be made of stainless steel.

Another aspect of the invention provides a boring system for a copper tubing. The boring system comprises a boring head in the above, and a tubing pipe sizing tool configured for receiving a rear end of the copper tube and being hit by an external force to drive the boring head into the external medium.

The tubing pipe sizing tool comprises a main body; a measuring portion provided on a first part of the main body in a first direction; a handle-installing hole provided on a second part of the main body in a second direction perpendicular to the first direction; a bump portion provided around an opening of the handle-installing hole; and a handle configured to engage the handle-installing hole and facilitate pipe sizing.

The advantages of the present invention are: (1) the boring head according to the invention enables the copper tubing work much more efficiently; and (2) the boring head is simple in structure and usage.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a tubing pipe sizing tool for measuring an outer diameter of a pipe according to an embodiment of the invention;

FIG. 2 is a perspective view of a tubing pipe sizing tool for measuring an inner diameter of a pipe according to an embodiment of the invention;

FIG. 3 is a perspective view of a tubing pipe sizing tool for measuring an outer diameter of a pipe with a handle installed according to an embodiment of the invention;

FIG. 4 is a perspective side view of the tubing pipe sizing tool for measuring an outer diameter of a pipe of FIG. 1;

FIG. 5 is a perspective side view of a tubing pipe sizing tool for measuring an inner diameter of a pipe of FIG. 2;

FIG. 6 is a perspective side view of a tubing pipe sizing tool for measuring an outer diameter of a pipe of FIG. 3 according to an embodiment of the invention;

FIG. 7 is a conceptual side cross-sectional view showing a tubing pipe sizing tool for measuring an inner diameter of a pipe according to an embodiment of the invention;

FIG. 8 is a conceptual side cross-sectional view showing a tubing pipe sizing tool for measuring an outer diameter of a pipe according to an embodiment of the invention;

FIG. 9 is a conceptual side cross-sectional view showing a tubing pipe sizing tool for measuring an outer diameter of a pipe with a stop according to an embodiment of the invention;

FIG. 10 is a conceptual side cross-sectional view showing a tubing pipe sizing tool for measuring an outer diameter of a pipe without a stop according to an embodiment of the invention;

FIG. 11 is a perspective view showing a boring head and tubing pipe sizing tool according to an embodiment of the invention;

FIG. 12 is a perspective view showing the boring head of FIG. 11; and

FIG. 13 is another perspective view showing the boring head of FIG. 11.

### DETAILED DESCRIPTION EMBODIMENTS OF THE INVENTION

Referring to the figures, the embodiments of the invention are described in detail.

The U.S. patent application Ser. No. 15/243,096 for “Tubing Pipe Sizing Tool” filed on 22 Aug. 2016 by the inventor is incorporated by reference into this disclosure as if fully set forth herein.

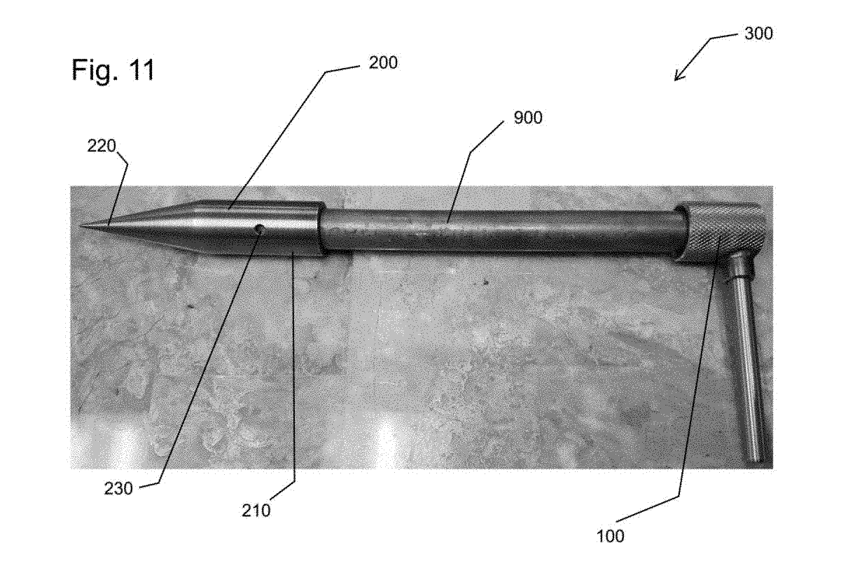

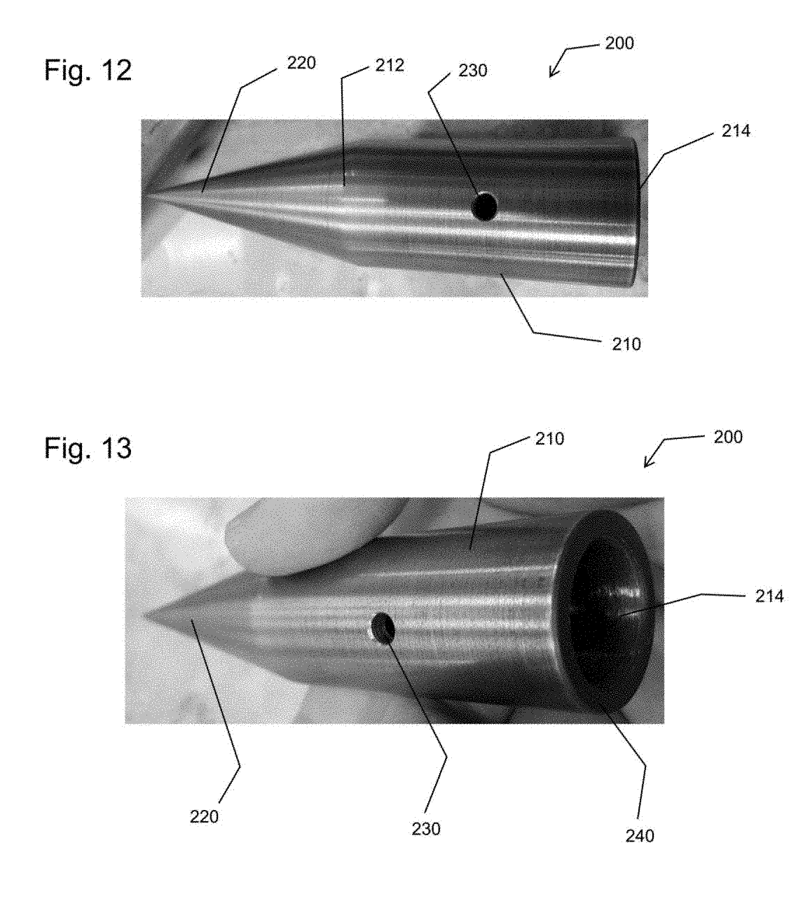

FIGS. 11-13 show a boring head and tubing pipe sizing tool according to an embodiment of the invention.

An aspect of the invention provides a boring head 200 for copper tubing.

The boring head 200 for copper tubing comprises a cylindrical body 210, a conic point 220, and a fixing hole 230.

The cylindrical body 210 has a predetermined inner diameter and a predetermined outer diameter with a front opening 212, a rear opening 214, and a concentric rear end portion 240.

The conic point 220 extends from the front opening 212 of the cylindrical body 210, and the conic point 220 is configured to penetrate and bore a hole through an external medium (not shown).

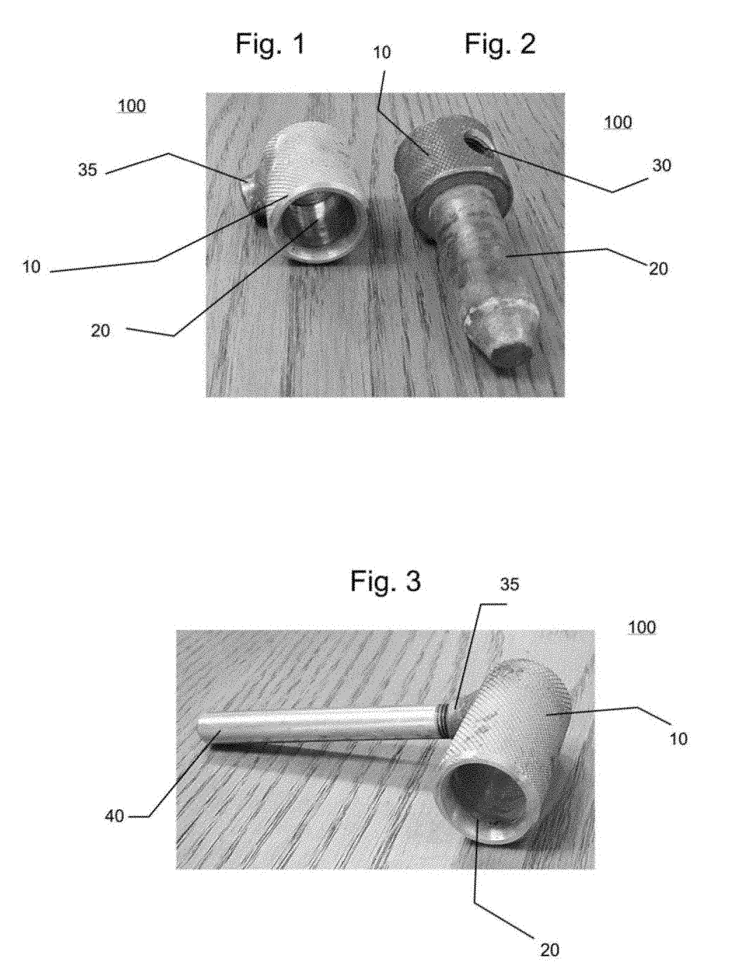

The fixing hole 230 is provided through a side wall of the cylindrical body 210 and configured to fix a copper tube 900 put into the cylindrical body 210 as shown in FIG. 1.

The conic point 220 makes a hole through the external medium, leading the copper tube 900 through the hole.

The conic point 220 may have a predetermined cross-sectional angle, which is determined by the external medium or its density or mechanical strength of the external medium.

The predetermined cross-sectional angle may be in a range from about 15 degrees to about 45 degrees.

Still, the predetermined cross-sectional angle may be from about 20 degrees to about 30 degrees.

Preferably, the predetermined cross-sectional angle may be about 25 degrees.

The thickness of the cylindrical body 210 may be approximately one fourth to one sixth of the diameter of the inner diameter of the cylindrical body 210.

The cylindrical body 210 and the conic point 220 may be formed monolithically or integrally.

The cylindrical body 210 and the conic point 220 may be made of stainless steel.

Another aspect of the invention provides a boring system 300 for a copper tubing as shown in FIG. 11. The boring system 300 comprises a boring head 200 in the above, and a tubing pipe sizing tool 100 configured for receiving a rear end of the copper tube 900 and being hit by an external force to drive the boring head 200 into the external medium as shown in FIG. 11.

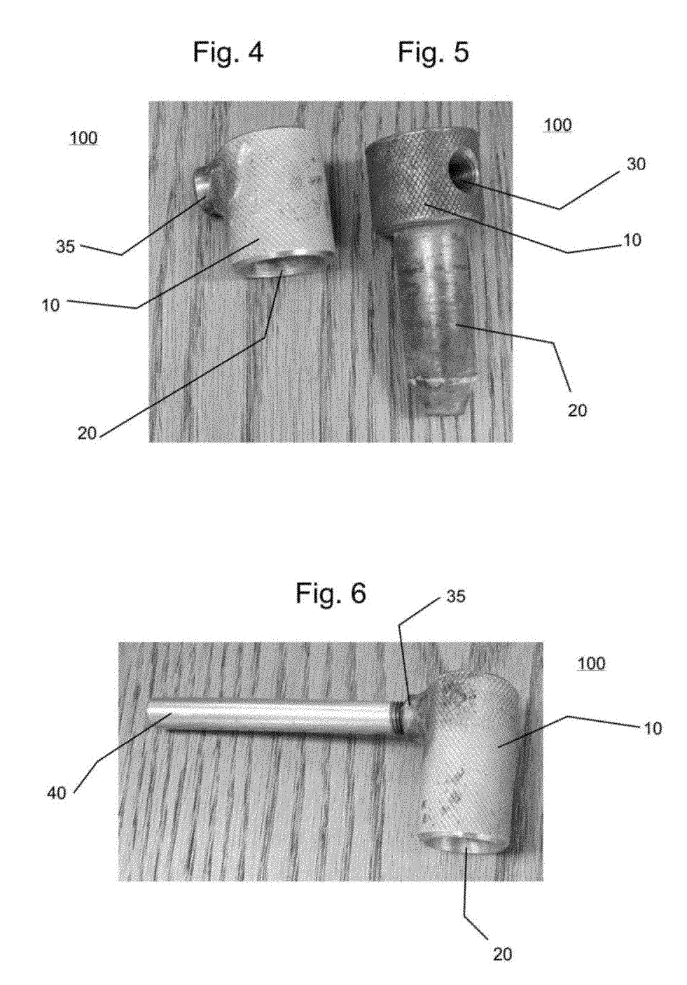

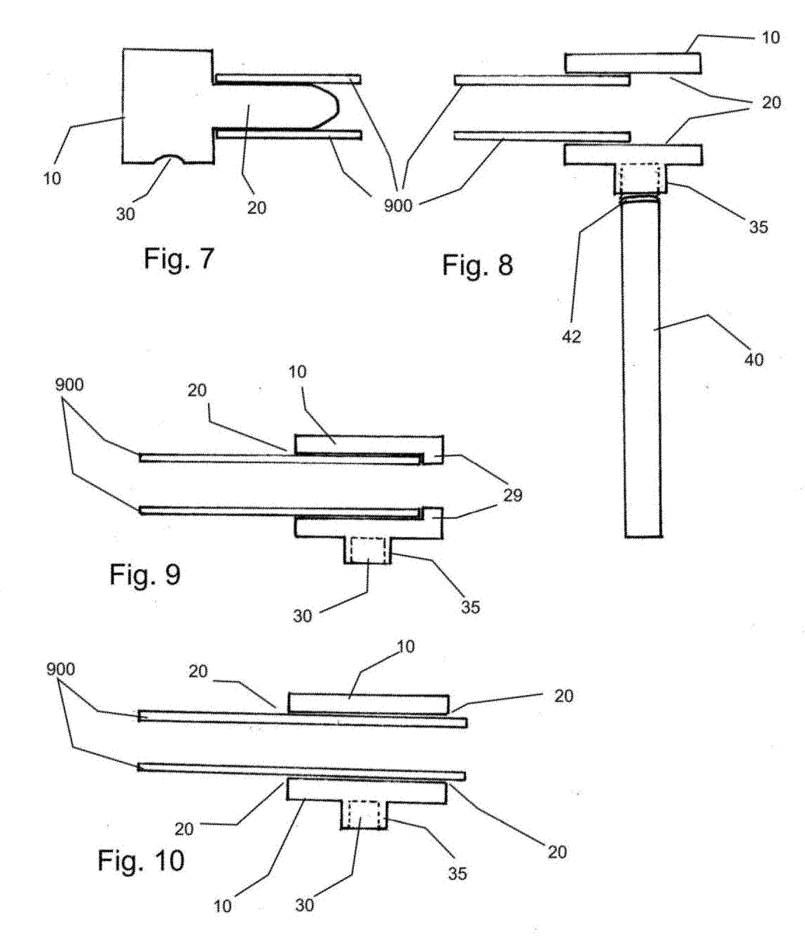

FIGS. 1 through 6 show various tubing pipe sizing tools according to embodiments of the invention, and FIGS. 7 through 10 show how the tubing pipe sizing tools are used in a couple of situations.

The tubing pipe sizing tool 100 comprises a main body 10, a measuring portion 20, a handle-installing hole 30, a bump portion 35, and a handle 40 as shown in FIGS. 1, 2, 4, 5, 7, and 8.

The measuring portion 20 is provided on a first part of the main body 10 in a first direction.

The handle-installing hole 30 is provided on a second part of the main body 20 in a second direction perpendicular to the first direction.

The bump portion 35 is provided around an opening of the handle-installing hole 30.

The handle 40 is configured to engage the handle-installing hole 30 and facilitate pipe sizing.

The main body 10 may have a cylindrical shape. However, it is not limiting. For example, the outer shape can be a polygon as long as to accommodate the other components such as the measuring portion.

The measuring portion 20 may be provided along a central axis of the cylindrical shape of the main body 10.

The measuring portion 20 may comprise a measuring cylinder portion protruding in the first direction for measuring a first size or inner diameter of an external pipe 900 as shown in FIGS. 2, 5, and 7.

Alternatively the measuring portion 20 may comprise a measuring tube portion extending in the first direction for measuring a second size or outer diameter of an external pipe 900 as shown FIGS. 1, 3, 4, 6, and 8.

The handle-installing hole 30 may be bored into a side of the cylindrical shape of the main body 10 as shown in FIGS. 7 and 8.

The handle-installing hole 30 may comprise a helical female thread provided on the inner surface of the handle-installing hole 30 as shown indirectly in FIG. 8.

The handle 40 may comprise a helical male thread 42 on an end portion of the handle 40, so as to engage the helical female thread of the handle-installing hole 30 as shown in FIG. 8.

The main body 10, the measuring portion 20, and the handle-installing hole 30 may be made monolithically.

The main body 10, the measuring portion 20, the handle-installing hole 30, and the handle 40 may be made of metal.

The bump portion 35 may have a cylindrical shape protruding in the direction of the handle 30, configured for being hit loose by an external force. Sometimes, when the plumber inserted the tool 100 in the external pipe 900, the tool 100 may be stuck in there. If the space is small or crowded, it is very challenging to retrieve the tool 100 from the pipe 900. In such a situation, the handle 40 helps a lot, and next the bump portion 35 can be a simple solution. If the bump portion 35 be hit by a hammer or so, the tool 100 can be loose and retrieved.

The measuring portion 20 may comprise a measuring tube portion extending in the first direction for measuring a second size or outer diameter of an external pipe, and the measuring tube portion has a specific measuring depth as shown in FIGS. 1, 3, 4, 6, and 8.

The measuring tube portion have a measuring length along the entire length of the measuring portion, so that the measuring tube portion can be used bidirectionally and all the way through as shown in FIG. 10. This features can be very useful in a copper coupling without a stop. As far as the inventor knows, there has been no such a convenient tool for the specific job.

Alternatively, the measuring tube portion may comprise a stopper 29 provided at a rear end thereof, so as to limit the insertion of the pipe 900 into the measuring tube portion.

The measuring tube portion may be provided with a plurality of diameters and lengths. The diameter may include a half inch, three quarters inch, one and a quarter inch, etc.

A preferably set of tools for sizing of pipe of one specific diameter may contain a first tool 100 for measuring an inner diameter of pipe, a second tool 100 for measuring an outer diameter of pipe (a short one or a first length or depth), a third tool 100 for measuring an outer diameter of pipe (a long one or a second length or depth), and a handle 40.

In certain embodiments of the invention, the boring head 200 can be applied to a galvanized pipe. Actually, it can be used for leading any kind of pipe through a medium.

In certain embodiments of the invention, the fixing hole 230 may further comprise threaded portion as shown in FIG. 13, which can engage a screw and fix the tube 900, copper or galvanized pipe, more securely. The screw (not shown) can be a part of the boring head 200.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A boring head for copper tubing, the boring head comprising:
a cylindrical body having a predetermined inner diameter and a predetermined outer diameter with a front opening, a rear opening, and a concentric rear end portion;
a conic point extending from the front opening of the cylindrical body, wherein the conic point is configured to penetrate and bore a hole through an external medium; and
a fixing hole provided through a side wall of the cylindrical body and configured to fix a copper tube put into the cylindrical body,
wherein the conic point makes a hole through the external medium, leading the copper tube through the hole.

2. The boring head of claim 1, wherein the conic point has a predetermined cross-sectional angle, which is determined by the external medium.

3. The boring head of claim 2, wherein the predetermined cross-sectional angle is from about 15 degrees to about 45 degrees.

4. The boring head of claim 3, wherein the predetermined cross-sectional angle is from about 20 degrees to about 30 degrees.

5. The boring head of claim 4, wherein the predetermined cross-sectional angle is about 25 degrees.

6. The boring head of claim 1, wherein the thickness of the cylindrical body is approximately one fourth to one sixth of the diameter of the inner diameter of the cylindrical body.

7. The boring head of claim 1, wherein the cylindrical body and the conic point are formed monolithically.

8. The boring head of claim 7, wherein the cylindrical body and the conic point are made of stainless steel.

9. A boring system for a copper tubing, the boring system comprising:
a boring head according to claim 1; and
a tubing pipe sizing tool configured for receiving a rear end of the copper tube and being hit by an external force to drive the boring head into the external medium.

10. The boring system of claim 9, wherein the tubing pipe sizing tool comprising:
a main body;
a measuring portion provided on a first part of the main body in a first direction;
a handle-installing hole provided on a second part of the main body in a second direction perpendicular to the first direction;
a bump portion provided around an opening of the handle-installing hole; and
a handle configured to engage the handle-installing hole and facilitate pipe sizing.
